(19) United States
(12) Patent Application Publication
(10) Pub. No.: US 2017/0052685 A1
(43) Pub. Date: Feb. 23, 2017

(54) USER EXPERIENCE FOR SOCIAL SHARING OF ELECTRONIC DATA VIA DIRECT COMMUNICATION OF TOUCH SCREEN DEVICES

(71) Applicant: TENTEN TECHNOLOGIES LIMITED, Hong Kong (CN)

(72) Inventors: Alexander Imre Kovács, Iruma-shi (JP); Douglas Schafer, Tokyo (JP)

(21) Appl. No.: 15/238,918

(22) Filed: Aug. 17, 2016

Related U.S. Application Data
(60) Provisional application No. 62/205,925, filed on Aug. 17, 2015.

(51) Int. Cl. G06F 3/0484; G06F 3/0481; G06F 3/0488

(52) U.S. Cl. CPC G06F 3/04845; G06F 3/0488; G06F 3/04817; G06F 3/04842; H04W 76/02

(57) ABSTRACT

A method for interaction between a first device and a second device, includes establishing, by the first device, direct connection with the second device; when at least one action for associating at least one electronic object associated with the first device with the second device is detected at the first device, sending, by the first device and to the second device, first data for enabling synchronized animations on displays of the first and second devices, through the established direct connection; and sending, by the first device and to a server which manages the at least one electronic object, second data for permitting the association of the at least one electronic object with the second device, through a network.

### RELATED APPLICATIONS

This application claims the benefit of U.S. Provisional Application No. 62/205,925, filed Aug. 17, 2015, the entire content of which is incorporated herein by reference.

### FIELD

The present disclosure relates to improved user experience for secured social sharing of electronic data via direct communication of touch screen devices.

### BACKGROUND

With regards to management of data on servers, electronic value has been widely adopted in commerce. A form of electronic value is software that allows the transfer of value on computer networks, particularly the Internet. Examples of electronic value are electronic money, bank deposits, electronic funds transfer, direct deposit, payment processors, electronic coupon and digital currencies such as points.

Sharing data between mobile devices in general can be accomplished via many technologies. Such technologies usually require shared network accessibility. Sharing of data between devices in proximity without requiring network connectivity can be accomplished by directly connecting devices via Bluetooth, Bluetooth Low Energy (Bluetooth LE), Direct Wi-Fi or similar. Methods for the latter category include Apple's AirDrop technology.

### SUMMARY

The present disclosure provides a description of devices and methods for improved user experience for sharing of electronic data.

One of the exemplary embodiments provides a method for interaction between a first device and a second device, comprising: establishing, by the first device, direct connection with the second device; when at least one action for associating at least one electronic object associated with the first device with the second device is detected at the first device, sending, by the first device and to the second device, first data for enabling synchronized animations on displays of the first and second devices, through the established direct connection; and sending, by the first device and to a server which manages the at least one electronic object, second data for permitting the association of the at least one electronic object with the second device, through a network.

### BRIEF DESCRIPTION OF THE DRAWINGS

The scope of the present disclosure is best understood from the following detailed description of exemplary embodiments when read in conjunction with the accompanying drawings. Included in the drawings are the following figures:

FIG. 1 shows a schematic view of a value transfer system according to an exemplary embodiment of the present invention.

FIG. 2 shows a chart for transferring electronic value between the users of the devices according to the embodiment.

FIG. 3A shows the item selection screen displayed on the first screen according to the embodiment.

FIG. 3B shows the first and second screens according to the embodiment.

FIG. 3C shows the first and second screens according to the embodiment.

FIG. 3D shows the first and second screens according to the embodiment.

FIGS. 3E, 3F, 3G, 3H show the first and second screens according to the embodiment.

FIGS. 4A, 4B, 4C, 4D, 4E show the first and second screens according to another embodiment.

FIG. 5 shows first and second screens according to a further embodiment.

FIGS. 6A, 6B, 6C show the first and second screens according to a still further embodiment.

FIGS. 7A, 7B, 7C show the first, second and third screens according to a still further embodiment.

FIG. 8 shows a hardware configuration diagram of the first device according to some embodiments of the present invention.

FIG. 9 is a hardware configuration diagram of the value management server according to some embodiments of the present invention.

### DETAILED DESCRIPTION

The present disclosure will be explained below using specific embodiments for explanatory purposes, but it should be understood that the scope is not limited to these embodiments.

In embodiments of the present invention, a method for creating a visual effect or an illusion of transferring an object from one mobile device with a touch screen to another such device via direct manipulation is provided. This method allows the sharing of data via direct manipulation between mobile touch screen devices in close proximity in order to improve user experience. This method is suitable for use cases where users loose ownership of the object being visually transferred between devices; however, this method is not limited to such use cases.

In some embodiments, a method according to the embodiments has the end effect similar to that of the background technologies (data is transferred from one mobile device to another). The method differs in how the transfer of data is accomplished by the user: instead of just initiating the data transfer by selecting the target device, the method allows users to directly manipulate a graphical representation of the data transmitted (such as a photo) in such a way that swiping that graphical representation out of the screen of one device, makes it appear on the screen of the other device, thus creating the visual effect of a physical object being passed.

In some embodiments, the purpose of the embodiments is to add a realistic dimension to the act of sharing data between two mobile devices in close proximity. By allowing the user to directly manipulate (via touch) and swipe (or push over) a graphical representation of the data being shared to the other device, the visual effect is created that the object was handed over just like that a physical object in the real world is passed from one person to another. The visual effect becomes quite realistic, when manipulations of the graphical representation on one device (such as rotating or dragging) are mirrored in real-time on the screen of the other device in a precise manner, and if other properties (like velocity of the manipulation of the graphical representation) are also taken into account.

In some embodiments, a method for transferring or sharing at least one object from a device or the user of the device to at least one other device or at least one user of the other device is provided. The method, which is implemented on the device, includes establishing direct connection with the at least one other device; when at least one action for transferring or sharing is detected, sending first data for enabling synchronized animations or collaborative animations on displays of the device and at least one other device, through the established direct connection; and sending, to a server which manages the at least one object, second data for permitting the transfer or sharing of at least one object, through a network.

In some embodiments, a device implementing the above method is provided.

In some embodiments, a method for transferring or sharing at least one object from a device or a user of the device to another device or a user of the other device is provided. The method, which is implemented on the other device, includes establishing direct connection with the device; receiving, through the established direct connection, first data for enabling synchronized animations on displays of the device and the another device; and receiving, from a server which manages the at least one object, second data for indicating the result of the transfer or sharing of the at least one object, through a network.

In some embodiments, a device implementing the above method is provided.

In some embodiments, the managing server stores the fact that a first user has shared an item with a second user, which indicates a real-world social interaction, in order to build up user profiles and a network of those real-world social interactions for further use, such as digital marketing.

In some embodiments, electronic data (such as photos, video, documents, music or contact information) or electronic value (such as points, coupons or e-money) is stored and managed on a managing server. A first device is capable of communicating with the managing server. A first user of the first device has a first account on the managing server. A second device is capable of communicating with the managing server. A second user of the second device has a second account on the managing server. The first device (or the first user) and the second device (or the second user) are situated in close proximity. Direct communication or direct connection (such as Bluetooth, Bluetooth LE, Near Field Communication (NFC), Infrared or Direct Wi-Fi) is established between the first device and the second device, in which nothing intervenes in the communication between the two devices or in which nothing relays the communication between the two devices.

The first user wishes to transfer, to the second user, the ownership of the data or the value. A graphical representation (such as an icon or a thumbnail) of the data or the value to be transferred is displayed on a touch screen of the first device. The first user swipes or drags the representation on the touch screen and this triggers (i) synchronized animations displayed on touch screens of the first and second devices and (ii) verification of the transfer on the managing server. In the case of the electronic data, since the data itself is not sent through the direct connection but rather small amount of data (such as information related to the location of the representation or related to the characteristics of the swipe or the drag) is sent, virtually any kind of smooth and/or natural animations on the touch screens can be realized regardless of the size of the data being represented. This may contribute to improvement of user experience. The similar discussion applies to the case of the electronic value, since verification could, but doesn't have to be conducted through the direct connection. The security of the transfer/transaction is more rigid in a case where each of the two users can watch the other's device's screen.

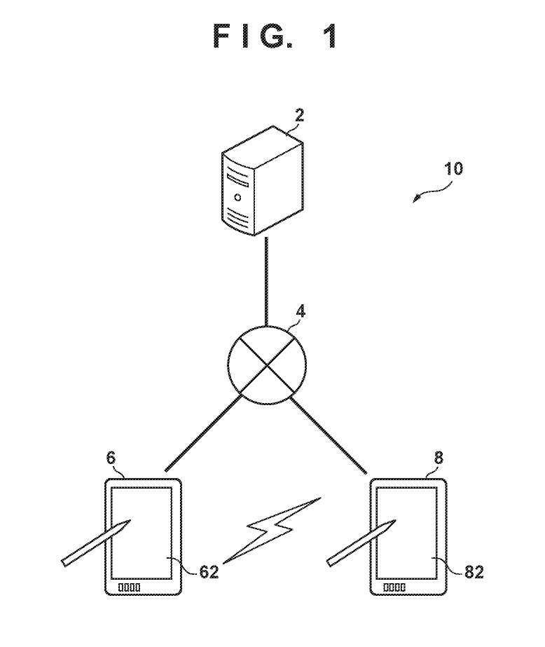

FIG. 1 shows a schematic view of a value transfer system according to an exemplary embodiment of the present invention. The value transfer system 10 comprises a value management server 2; a network 4; a first device (or Device 1) 6; and a second device (or Device 2) 8.

The value management server 2 stores and manages electronic values associated with users. In particular, each user of the system (or a service provided by the system) holds its own account, and an account is associated with a respective electronic value in a value database of the server 2. The server 2 manages the electronic value and has functions of, among others, receiving the request for transferring an amount of electronic value from one account to another account, verifying the transfer, updating the value database and notifying the results of the transfer request to participating devices.

The network 4 may be wired or wireless or the combination thereof. The network 4 may be the Internet, Ethernet, Local Area Network (LAN), Wide Area Network (WAN), or any other kind of network or any combination thereof.

The first device 6 may be a mobile phone, a smartphone, a tablet or any other kind of mobile device with a first touch screen 62. Software is installed on the first device 6. The software may be pre-installed or may be downloaded through the network 4. The first device 6, by executing the software, realizes the functions of connecting to the network 4, communicating with the server 2 through the network 4, establishing direct connection with the second device 8 and other functions as described below. The second device 8 with a second touch screen 82 is configured similarly to the first device 6.

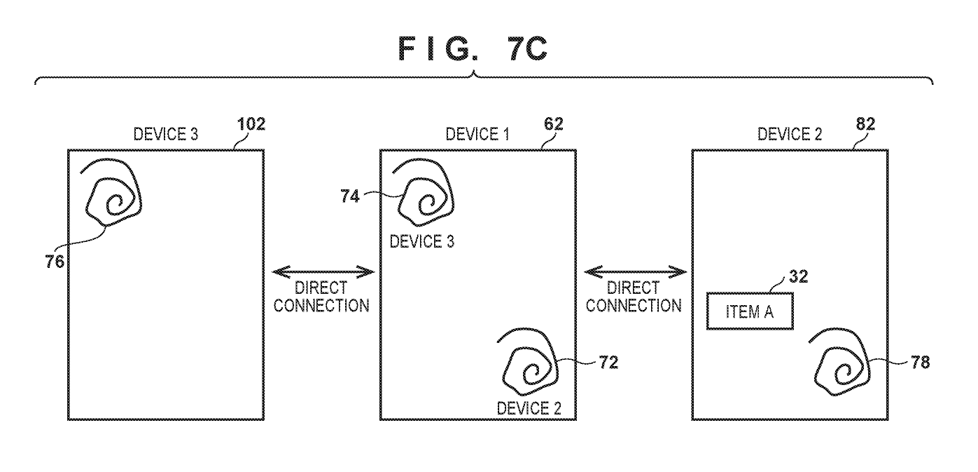

FIG. 8 shows a hardware configuration diagram of the first device 6 according to some embodiments of the present invention. The second device 8 has a hardware configuration similar to that shown in FIG. 8. The first device 6 comprises a central processing unit (CPU) 601, a random access memory (RAM) 602, a read-only memory (ROM) 603, a storage unit 604, a transmitter 605, and a receiver 606, an output device 607 and an input device 608. All of these components are connected to each other by a bus 609.

The CPU 601 is a hardware processor that can control overall operation of the first device 6 by reading a computer program that is stored in the ROM 603 into the RAM 602, and executing instructions of the program. For simplicity only a single CPU 601 is illustrated, but it should be noted that there may be multiple instances of the CPU 601 that work in cooperation to execute instructions for achieving the functionality of the first device 6. The CPU 601 may be any processor capable of executing instructions of the program.

The transmitter 605 is a device for transmitting data in accordance with a particular communication specification such as BLE to the second device 8 or to the value management server 2, for example. The transmitter 605 may also transmit data packets over a computing network such as the Internet and include various types of interfaces such as, for example, universal serial bus (USB), Ethernet, IEEE1394, radio frequency (RF), near-field communications, 802.11 (WiFi), TCP/IP and the like. The CPU 601 controls the transmitter 605 to transmit data in accordance with the program by sending control signals to the transmitter 605 via the bus 609.

The receiver 606 is a device for receiving data in accordance with a particular communication specification such as BLE from the second device 8 or from the value management server 2, for example. The receiver 606 may also receive data packets over a computing network such as the Internet and includes various types of interfaces such as, for example, universal serial bus (USB), Ethernet, IEEE1394, radio frequency (RF), near-field communications, 802.11 (WiFi), TCP/IP and the like. The CPU 601 may control the receiver 606 to receive data in accordance with the program by sending control signals to it via the bus 609.

The storage unit 604 is a non-volatile storage device capable of storing various kinds of data. In some embodiments, the storage unit 604 is a built-in memory device, for example, and in other embodiments it is detachably mounted to the first device 6.

The output device 607 is a device for presenting information to the user of the first device 6, such as a display of an LCD or the screen of mobile phone for example, that outputs information to the user of the first device 6. The display 607 may be built into the first device 6, or may be externally attached to the first device 6.

The output device 607 is not limited to visual output devices, and may comprise an audio output device, for example, such as a speaker.

The input device 608 is a device that the user of the first device 6 uses to input information into the first device 6. The input device 608 may be a touch panel device that is built into the display 607 integrally. The input device 608 and the output device 607 together may be implemented as a touch screen. The input device 608 is not limited to this, however, and may comprise an audio input device such as a microphone.

In some embodiments, the functionality of the first device 6 can be realized by the CPU 601 executing a software program stored in the ROM 603 using the RAM 602 as a work area. In accordance with the program, the CPU 601 can control the operation of the other components of the first device 6 by sending controls signals thereto, and receiving signals therefrom over the bus 609.

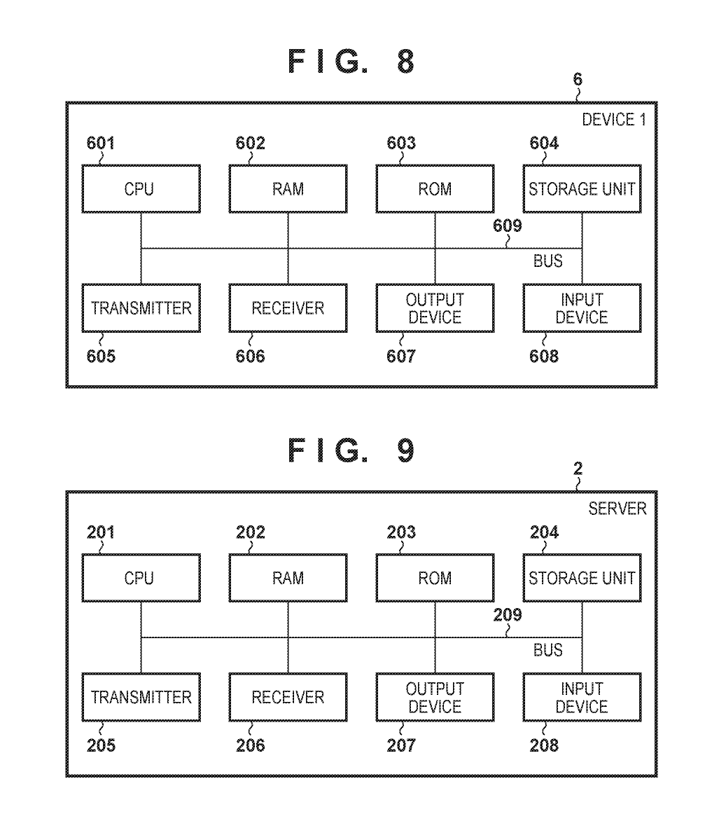

FIG. 9 is a hardware configuration diagram of the value management server 2 according to some embodiments of the present invention. The value management server 2 comprises a central processing unit (CPU) 201, a RAM 202, a ROM 203, a storage unit 204, a transmitter 205, and a receiver 206, an output device 207 and an input device 208. All of these components are connected to each other by a bus 209.

The CPU 201 is a hardware processor that can control overall operation of the value management server 2 by reading a computer program that is stored in the ROM 203 into the RAM 202, and executing instructions of the program. For simplicity only a single CPU 201 is illustrated, but it should be noted that there may be multiple instances of the CPU 201 that work in cooperation to execute instructions for achieving the functionality of the value management server 2. The CPU 201 may be any processor capable of executing instructions of the program.

The transmitter 205 is a device for transmitting data to the first device 6 or the second device 8 via the network 4. The transmitter 205 may transmit data packets over a computing network such as the Internet and include various types of interfaces such as, for example, universal serial bus (USB), Ethernet, IEEE1394, radio frequency (RF), near-field communications, 802.11 (WiFi), TCP/IP and the like. The CPU 201 can control the transmitter 205 to transmit data in accordance with a program by sending control signals to it via the bus 209.

The receiver 206 is a device for receiving data from the first device 6 or the second device 8 via the network 4. The receiver 206 may receive data packets over a computing network such as the Internet and includes various types of interfaces such as, for example, universal serial bus (USB), Ethernet, IEEE1394, radio frequency (RF), near-field communications, 802.11 (WiFi), TCP/IP and the like. The CPU 201 may control the receiver 206 to receive data in accordance with the program by sending control signals to it via the bus 209.

The storage unit 204 is a non-volatile storage device capable of storing various kinds of data. In some embodiments, the storage device is a built-in memory device, for example, and in other embodiments it is detachably mounted to the value management server 2.

The output device 207 is a device, such as a display of an LCD for example. The input device 208 is a device used to input information or an instruction into the value management server 2.

In some embodiments, the functionality of the value management server 2 can be realize by the CPU 201 executing a software program stored in the ROM 203 using the RAM 202 as a work area. In accordance with the program, the CPU 201 can control the operation of the other components of the value management server 2 by sending controls signals thereto, and receiving signals therefrom over the bus 209.

The value management server 2 may be built into or externally mounted to a vending machine, a POS terminal (Point of Sale), a ticketing machine, an automated teller machine (ATM) or any other device which can deal with the electronic value.

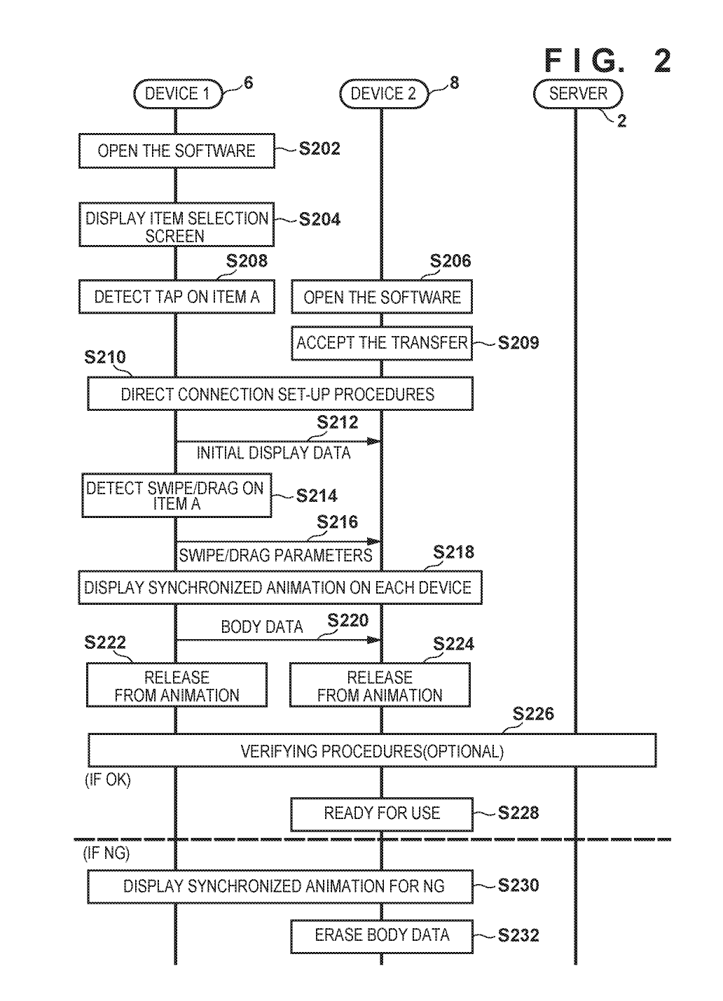

FIG. 2 shows a chart for transferring electronic value between the users of the devices according to the present embodiment. Assume that the first user of the first device 6 wishes to transfer a part of their electronic value (ex. 20 points out of total 160 points) to the second user of the second device 8 who is situated in proximity to the first user. The first user taps an icon for the software (not shown) on the touch screen 62. The first device 6 detects the tap and executes or opens the software in step S202. The following actions of the first device 6 are performed by a Central Processing Unit or Units (CPU) or other processor(s) of the first device 6 executing the software. The first device 6 communicates with the server 2 via the network 4 in order to log in to the first user's account. Credentials such as user name and password, which may be input by the first user or stored in the first device 6, may be used for login. The login can happen before the following interaction, which does not assume or require a connection to the network. The first device 6 displays an item selection screen on the touch screen 62, so that the first user can select which electronic value or how much of the electronic value is to be transferred, in step S204.

The second user taps an icon for the software (not shown) on the touch screen 82. The second device 8 detects the tap and executes the software in step S206. This may be induced by the first user talking with the second user. The following actions of the second device 8 are performed by CPU(s) or other processor(s) of the second device 8 executing the software. The second device 8 allows the second user to login as the first device 6 does.

The first user may tap on the graphical representation of the part of the electronic value (ex. 20 points out of total 160 points), on the item selection screen. In this example, the first user selects an item A (ex. corresponding to 20 points) by tapping on the graphical representation corresponding to the item A. The first device 6 detects the tap on the graphical representation in step S208. When the first device 6 detects the tap on the graphical representation, the first device 6 initiates direct connection setup procedures with the second device 8 in steps S209 and S210. The details of the procedures depend on which technology is adopted for the direct connection. For example, if Bluetooth LE is adopted, the first device 6 prepares and sends advertisement signals for offering connection and the second device 8 detects the advertisement signal. The second device 8 asks the second user whether to accept the connection. If accepted, the second device 8 sends a connection request to the first device 6. Establishing the direct connection itself may be realized by a known art and will not be further described in this disclosure.

After the tap on the graphical representation is detected, the first device 6 shows the graphical representation of the item A on a predetermined starting position or location of the touch screen 62. After the direct connection is established, the first device 6 sends, to the second device 8, initial display data relating to the item A through the direct connection in step S212. The initial display data includes the starting position and the rotation angle of the graphical representation. Optionally, the initial display data may include image data of the graphical representation or the size of the first touch screen 62. The starting position of the graphical representation may be designated in ratio (or percentile) of the distance from the top edge of the screen to the total longitudinal length of the screen and ratio (or percentile) of the distance from the right edge of the screen to the total transverse length of the screen. By sharing the ratio instead of pixels or points, there is no need to share the screen size of the first touch screen 62 with the second device 8 and vice versa.

In reply to the initial display data or during the direct connection set-up procedures in step S210, the first device 6 receives data including the second user's account information from the second device 8. This data will be sent to the managing server as part of the verifying procedure and stored by the server as part of the social profile of both the first and second user.

The first user swipes or drags the graphical representation of the item A on the first touch screen 62 to initiate the transfer. The first device 6 detects the swipe or the drag of the item A in step S214. The first device 6 prepares and sends swipe/drag data including swipe/drag parameters through the direct connection in step S216. The swipe/drag parameters characterize the detected swipe or drag. The parameters will be discussed later in relation to the details of synchronized animations.

When the swipe or drag of the graphical representation of the item A is detected, the first device 6 prepares and displays a first animation on the first touch screen 62 in step S218. The first animation is prepared based on at least one of the contents of the swipe/drag parameters. In the first animation, the graphical representation of the item A shows continuous or gradual change towards disappearance.

When the swipe/drag data is received, the second device 8 prepares and displays a second animation corresponding to or mirroring in real time or seamlessly connected to or synchronized with or paired with or in collaboration with or visually succeeding to the first animation in step S218. The second animation is prepared based on at least one of the contents of the initial display data and at least one of the swipe/drag parameters. In the second animation, the graphical representation of the item A shows continuous or gradual change towards appear in a manner responsive to the continuous or gradual change in the first animation. The first animation and the second animation together form synchronized animations. The synchronized animations may create a visual effect in which the graphical representation is handed over just like that a physical object in the real world is passed from the first user to the second user. The further details of the step S218 will be discussed later.

Optionally, if it is necessary to transfer, from the first device 6 to the second device 8, body data or additional data in addition to the initial display data or the swipe/drag parameters, the first device 6 prepares and sends such body data to the second device 8 through the established direct connection in step S220. In some cases where the transaction or actual data transfer occurs at the server 2, the step S220 may not be required.

Once the first animation ends, the first device 6 is released from the state for showing animation and becomes ready for accepting next action from the first user in step S222. So is the second device 8 in step S224.

When the swipe or drag of the representation of the item A is detected, the first device 6 prepares and sends, to the server 2 through the network 4, request for the transfer of the part of the electronic value from the first user's account to the second user's account. In case either or both of the devices do not have a connection to server 2 at this moment, the requests for transfer can be stored on the device(s) and be sent to the server at a later point in time, when a network connection is established. Successful sending of the request to transfer initiates verifying procedures at one of or among at least two of the first device 6, the second device 8 and the server 2 in step S226. Such verifying procedures may be realized by a known art (ex. procedures shown in PCT/JP2013/006735) and will not be further described in this disclosure. As described above, the verifying procedures are optional in the process shown in FIG. 2. In principle, there is no need for devices to be connected to the network 4. The visual sharing can end in a state where both devices tentatively assume that the authorization was granted. Actual use of the shared item may be possible after the transfer has happened on the server 2 and data is downloaded from the server 2 to the second device 8.

If the verification process succeeds, the second device 8 becomes ready for the use of the transferred part of the electronic value in step S228.

If the verification process fails or if the direct connection is lost at any point in a period from the detection of the swipe/drag (S214) to the end of the verification procedures (S226) or if any other error occurs, the first device 6 prepares and displays a third animation on the first touch screen 62 in step S230. In the third animation, the graphical representation of the item A shows continuous or gradual change towards re-appearance. Similarly, the second device 8 prepares and displays a fourth animation corresponding to or mirroring in real time or seamlessly connected to or synchronized with or paired with or in collaboration with or visually succeeding to the third animation in step S230. In the fourth animation, the graphical representation of the item A shows continuous or gradual change towards disappear in a manner responsive to the continuous or gradual change in the third animation. The third animation and the fourth animation together form further synchronized animations. The further synchronized animations may correspond to or pair with or be in collaboration with or visually succeed to the synchronized animations shown in step S218. For example, if the synchronized animations in step S218 are a unidirectional motion of the graphical representation from the first screen 62 to the second screen 82, the further synchronized animations in step S230 are “bounce-back”.

The second device 8 erases body data in step S232 if the transfer/transaction fails. In the case where the direct connection is lost, the fourth animation may not be required, although it is still possible to show such animation in case of loss by pre-creating the fourth animation and displaying the fourth animation when the loss of the direct connection is detected.

Once the synchronized animations end on both devices 6, 8, the item A has been visually transmitted and the transaction is complete as far as the users are concerned. In many applications, it is realized to register and validate the transaction between the first user and the second user on a third, trusted device, such as a server backend or the value management server 2. This may be realized for applications where (i) the shared item has some monetary value and (ii) the item should be removed from the first user's account and credited to the second user's account. Further, depending on the value of the shared item, additional security measures may be put in place to prevent fraud.

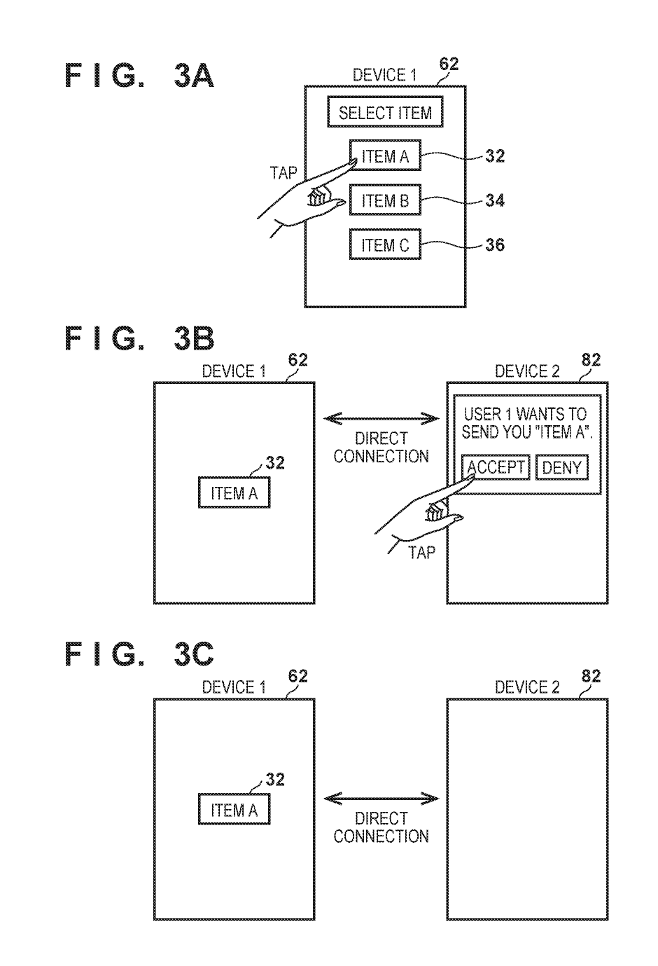

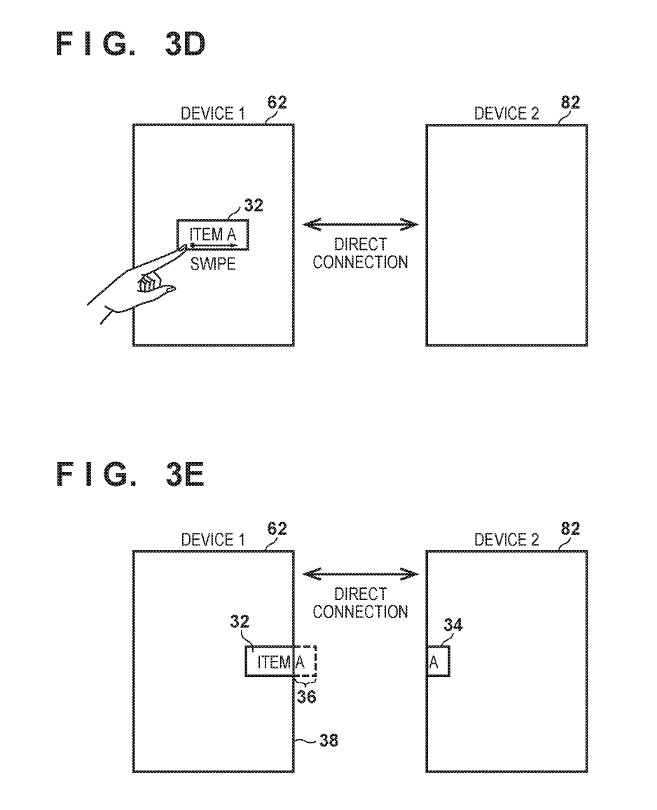

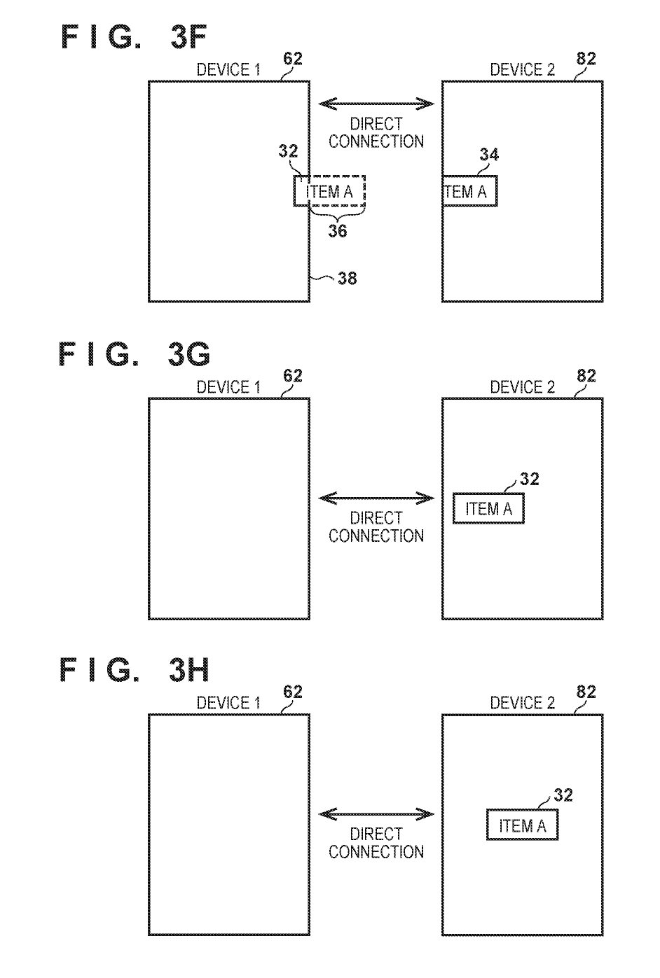

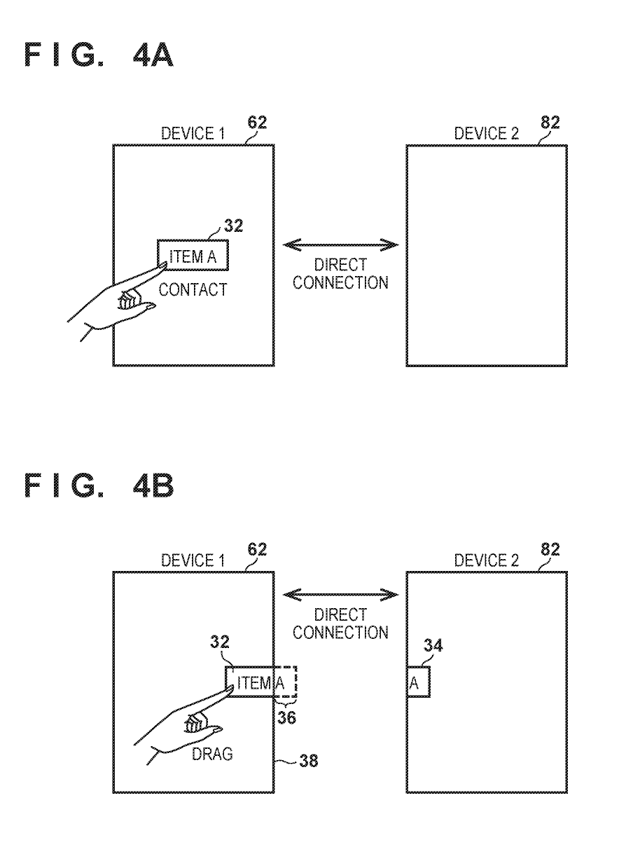

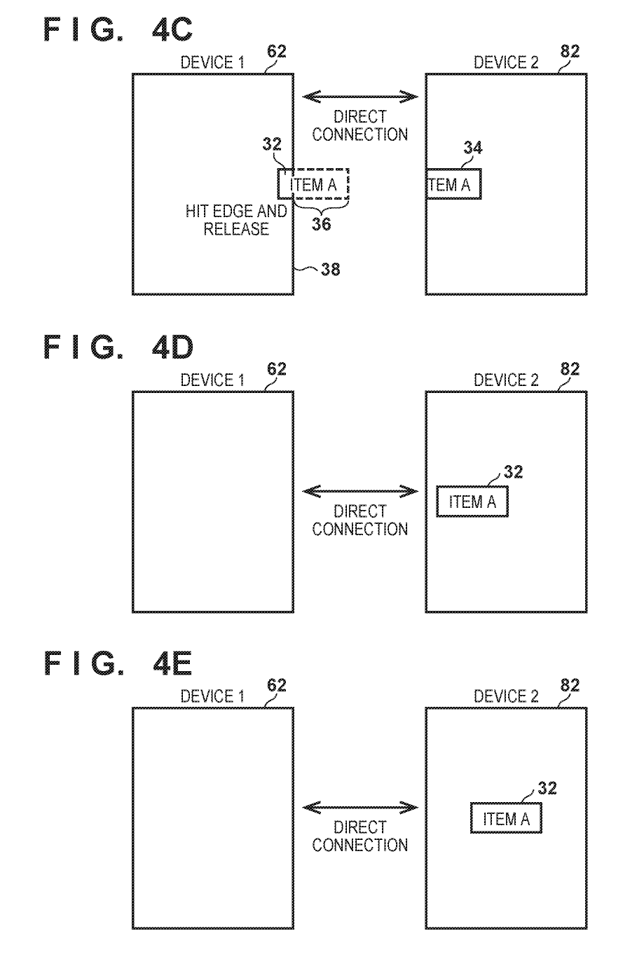

FIG. 3A shows the item selection screen displayed on the first screen 62 in step S204, according to the present embodiment. In the item selection screen, three graphical representations 32, 34, 36 corresponding to the items A, B, C, respectively are shown. The first user is expected to tap on one of the three representations to show his/her intent to send the respective value/data.

FIG. 3B shows the first and second screens 62, 82 in steps S209 and S210, according to the present embodiment. The first screen 62 shows the graphical representation 32 of the selected item A at a predetermined position. The appearance of the graphical representation 32 on the first screen 62 may be designated by a position of a reference point, a size and a rotational angle. The reference point of the representation 32 may be a geometrical center or a corner. The size and the position of the representation 32 may be transferred in absolute terms, not relative terms, to make it more realistic that the same item is being transferred. If the representation is inclined, the inclination angle of the representation may substantially be the same on both devices.

An alternative way of specifying the reference point and the size is that the position of the reference point may be transmitted from the first device in relative terms or in terms of percentage of the length of a reference edge (rather than absolute terms or pixels, points). For example, the representation 32 may be designated as: the center of the representation 32 is at 40 percent of the long edge from the top and 50 percent of the short edge from the right, and the size is 10 percent of the long edge and 50 percent of the short edge.

At step S209, the second screen 82 shows an acceptance screen, which asks the second user whether to accept the item A. If the second user taps on “Accept”, the process proceeds. Otherwise, the process is cancelled.

FIG. 3C shows the first and second screens 62, 82 in step S212, according to the present embodiment.

FIG. 3D shows the first and second screens 62, 82 in step S214, according to the present embodiment. The first user swipes the representation 32 on the first screen 62 and the first device 6 detects the swipe. The first device 6 measures the direction and velocity of the swipe as swipe/drag parameters characteristic to the detected swipe. The first device 6 shares the characteristic parameters with the second device 8 through the direct connection.

FIGS. 3E, 3F, 3G, 3H show the first and second screens 62, 82 in step S218, according to the present embodiment. These Figures show how the first and second animations are played on the first screen 62 and the second screen 82, respectively. The first device 6 plays the first animation on the first screen 62. In the first animation, the representation 32 moves in a direction corresponding to the swipe direction and with a velocity corresponding to the swipe velocity. In FIG. 3E, a part 36 of the representation 32 is off the first screen 62 and the part 36 is “sticking out” from the right edge 38 of the first screen 62. The second device 8, knowing the start position of the representation 32 and characteristic parameters of the swipe, can calculate which part of the representation 32 is off the first screen 62 and which edge it is “sticking out” from. The second device 8 can calculate a completion animation or the second animation, which moves the representation 32 to a predetermined position or the center of the second screen 82. In FIGS. 3E, 3F, the second device 8 displays only the part 34 of the representation 32 that is off the first screen 62 (but on the opposite edge), as a part of the second animation. This contributes to creating the visual effect of the item A actually being transferred over. Visual flourish, such as bouncing back animations can add to the realism of the sharing action between the devices. Further, if the first user doesn't give the representation 32 enough velocity to actually land completely on the second screen 82 but the part 34 of it are appearing on the second screen 82, the second user could be allowed to complete the swipe by pulling the item over by themselves (this could be disabled if the particular application of the present embodiment doesn't need or want this ability).

According to the present embodiment, each of the first user and the second user can see the other's screen, so that they can confirm the transaction of the value or the data. This contributes to the increase of the security of the transaction. In general, in a field of server-management-type of electronic value, one of the keys is to ensure the security of the transaction. In the present embodiment, the security is ensured by limiting the transaction between the users within a range of the direct connection (the transaction is not possible if the devices cannot communicate via the direct connection) and by allowing the users (the sender and the receiver) to confirm the transaction in person. Furthermore, the users' devices exchange information regarding the graphical representation of the electronic value through the direct connection, while the actual transfer happens in the value management server. Therefore, even if a third party can “sniff” the direct connection, the party cannot obtain any information to enable unauthorized transfer of electronic value. Therefore, secured sharing or transferring of electronic value can be realized.

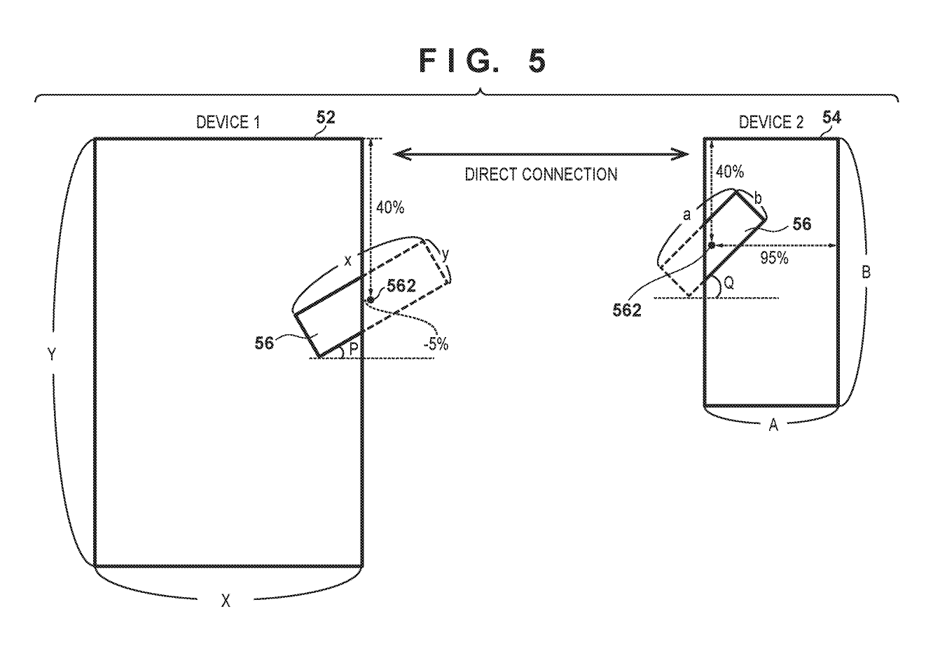

FIGS. 4A, 4B, 4C, 4D, 4E show the first and second screens 62, 82 in step S214, according to another embodiment. The first user contacts on and drags the representation 32 on the first screen 62 and the first device 6 detects the drag. While the first user drags the representation 32 on the first screen 62, the position of the center point of the representation 32 is continuously detected as a characteristic parameter of the drag. The first device 6 transmits the characteristic parameter to the second device 8 through the direct connection in real time.

In FIGS. 4B, 4C, a part 36 of the representation 32 is off the first screen 62 and the part 36 is “sticking out” from the right edge 38 of the first screen 62. The second device 8, knowing the current position of the representation 32 and the size of the representation 32, can calculate which part of the representation 32 is off the first screen 62 and which edge it is “sticking out” from. Based on that calculation, the second device 8 displays only the part 34 of the representation 32 that is off the first screen 62 (but on the opposite edge). This contributes to creating the visual effect of the item A actually being transferred over. In FIG. 4C, the first user's drag hits the right edge 38 and then the first user releases the representation 32. The first device 6 measures the direction and velocity of the release as characteristic parameters of the release. The first device 6 shares the characteristic parameters with the second device 8 through the direct connection. The second device 8, knowing the released position of the representation 32 and the characteristic parameters of the release, can calculate a completion animation, as in the case of swipe.

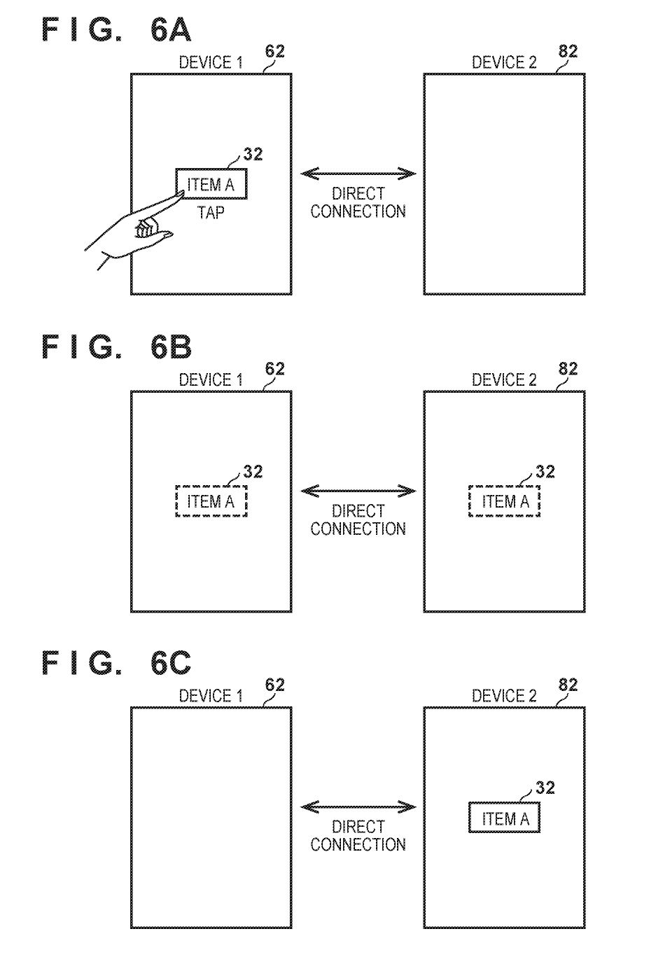

FIG. 5 shows first and second screens 52, 54, according to a further embodiment. In this embodiment, the size or the form of the first screen 52 is different from or larger than the size or the form of the second screen 54. The representation 56 is rotated or inclined with respect to the transverse direction in which the short edges of the screen extend. This further embodiment shows how to handle different screen sizes and rotation.

In FIG. 5, the lengths of the transverse edge (or the short edge) and the longitudinal edge (or the long edge) of the first screen 52 are denoted as “X”, “Y”, respectively. The lengths of the transverse edge and the longitudinal edge of the second screen 54 are denoted as “A”, “B”, respectively. The long edge of the representation 56 corresponds to the transverse edges of the first and second screens 52, 54 and its length is denoted as “x” for the first screen 52 and as “a” for the second screen 54. The short edge of the representation 56 corresponds to the longitudinal edges of the first and second screens 52, 54 and its length is denoted as “y” for the first screen 52 and as “b” for the second screen 54. The representation 56 is rotated at a rotational angle “P” on the first screen 52, the rotational angle being an angle between the transverse direction and the long edge of the representation 56. The corresponding rotational angle on the second screen 54 is denoted as “Q”.

The representation 56 has its reference point or its center 562. The first device with the first screen 52 sends, to the second device with the second screen 54 through the direct connection, the position of the center 562 as the position of the representation 56. For example, the first device determines that the longitudinal position of the center 562 is forty (40) percent of “Y” from the top short edge and that the transverse position of the center 562 is minus five (−5) percent of “X” from the right long edge. The first device sends the relative position or percentages (40, −5) to the second device. The second device translates the received percentages into the position of the center 562 on the second screen 54. In this case, the second device determines, based on the received position, that the longitudinal position of the center 562 is forty (40) percent of “B” from the top short edge on the second screen 54 and that the transverse position of the center 562 is ninety five (95) percent of “A” from the right long edge on the second screen 54.

The first device sends, to the second device through the direct connection, the dimensions or the size of the representation 56 in a relative term. For example, when the ratio of “x” to “X” or the value “x/X” is set to be 0.5 and the ratio of “y” to “Y” or the value “y/Y” is set to be 0.1 on the first screen 52, the first device sends the values (0.5, 0.1) to the second device. The second device translates the received values into the size of the representation 56 on the second screen 54. In this case, the second device determines, based on the received values, that the length “a” of the long edge of the representation 56 is A multiplied by 0.5 on the second screen 54 and that the length “b” of the short edge of the representation 56 is B multiplied by 0.1 on the second screen 54. In other embodiments, the size of the item could be transferred in absolute, not relative terms, to make it more realistic that the same item is being transferred.

The first device sends, to the second device through the direct connection, the rotational angle “P” of the representation 56. The second device translates the received angle into the rotational angle “Q” of the representation 56 on the second screen 54. The rule of translation or conversion of the angle is chosen so that the appearance of the representation 56 is natural in consideration of the possible difference in aspect ratio between the screens. In this case, it is assumed that a line inclined at the angle “P” on the first screen 52 with the aspect ratio of X:Y is affine transformed to a line inclined at the angle “Q” on the second screen 54 with the aspect ratio of A:B. Then simple math will provide that the tangent of “Q” is equal to the tangent of “P” multiplied by “B/A” and divided by “Y/X”. For example, assuming that “B/A” is 2 and “Y/X” is 1.6 and the tangent of “P” is 0.8 (or “P” is around 39 degrees), the tangent of “Q” is 1 and “Q” is 45 degrees.

Based on the above information, the second device displays the off-screen part of the representation 56 in a proportionally correct manner on the second screen 54 at the appropriate angle.

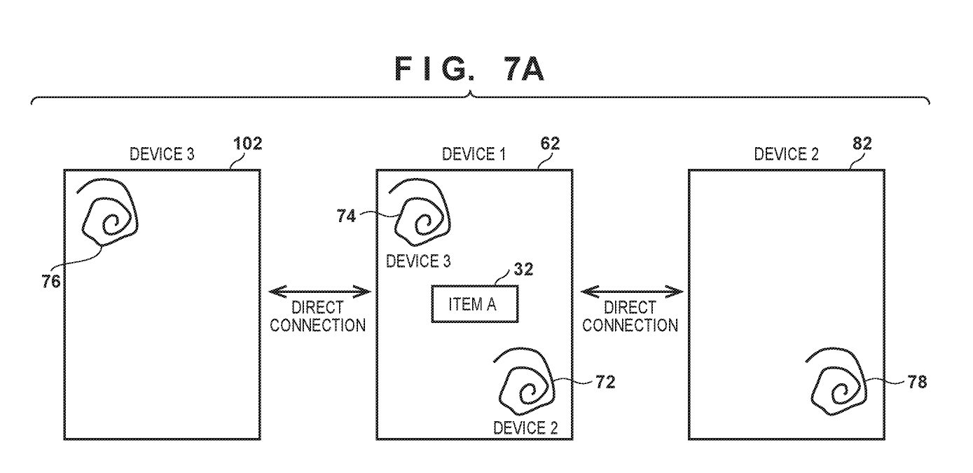

FIGS. 6A, 6B, 6C show the first and second screens 62, 82, according to a still further embodiment. In this embodiment, the first user taps on the representation 32 instead of swipe or drag. In the first animation, the representation 32 fades out. In the second animation, the representation 32 fades in. The speed of fade-in corresponds to or equivalent to or substantially equal to the speed of fade-out.

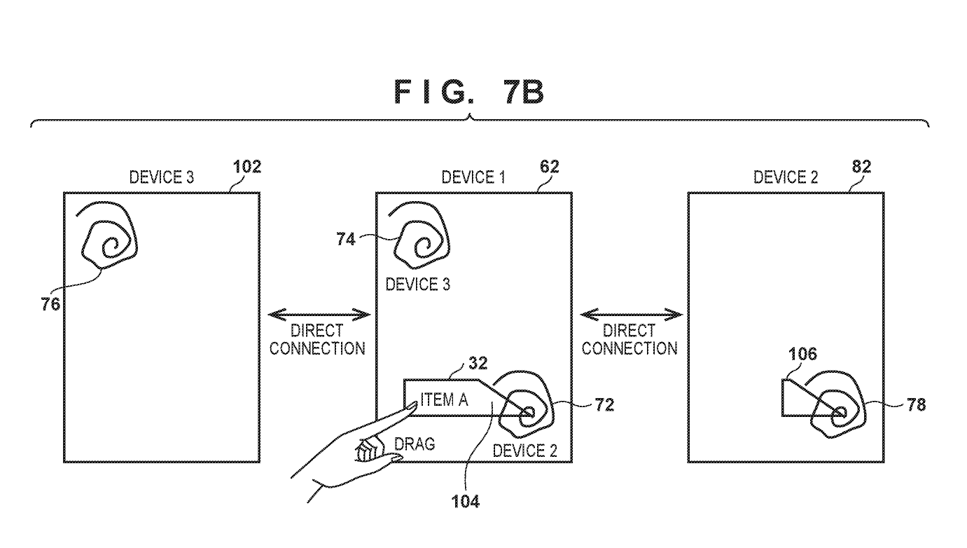

FIGS. 7A, 7B, 7C show the first, second and third screens 62, 82 and 102 according to a still further embodiment. In this embodiment, the first device 6 is in direct connection with both the second device 8 and a third device comprising the third screen 102. In FIG. 7A, the first screen 62 shows a destination selection screen in which graphical representations or wormholes 72, 74 corresponding to the second device 8 and the third device, respectively, are shown as well as the representation 32 of the item A. The second screen 82 of the second device 8 shows a graphical representation or a wormhole 78 corresponding to the wormhole 72 for the second device 8 shown on the first screen 62. The third screen 102 of the third device shows a graphical representation or wormhole 76 corresponding to the wormhole 74 for the third device shown on the first screen 62.

For example, the first user wishes to send the item A to the second user. The first user drags the representation 32 of the item A towards the wormhole 72 for the second device 8. When the representation 32 is in close proximity of the wormhole 72 or the distance between the representation 32 and the wormhole 72 is less than a threshold value, a part 104 of the representation 32 is shown to be “sucked in” the wormhole 72. Correspondingly, the respective part 106 of the representation 32 is “exhaled” from the wormhole 78 on the second screen 82. As the representation 32 gets close to the center of the wormhole 72 on the first screen 62, the representation 32 shrinks on the first screen 62 and it expands on the second screen 82. Once the entire representation 32 is sucked in the wormhole 72 on the first screen 62, the entire representation 32 is displayed on the second screen 82. This embodiment is advantageous in cases where there are multiple candidates for the destination of the data or the value.

In some embodiments, transferring an object from a first user to a second user may happen between the user devices instead of on-server. In this case, there is no need for the devices to be connected to the network 4. The object or the value or the data is sent through the direct connection. The object can be sent at any timing during the process. For example, there's no need to wait for data to be transmitted until the release of the representation. Data transmission can start immediately and any copied data can be discarded on the second device in case the sharing is not completed.

In the above some embodiments, the transfer of data between the devices may take a while (ex. several seconds) if the size of the data is big. One possible problem to be solved by some embodiments is “what happens if the velocity of swipe is so high that the animation at the second device ends before the completion of the data transfer?” If the second user has to further wait until the data transfer is completed even after the animation ends, the user may be irritated. To cope with this, in some embodiments of the present invention, data transfer is completed before the end of the animation at the second device.

In one embodiment, the first device calculates how long it takes to complete the data transfer at the time of detecting swipe on the representation of the item and to set a high limit for the velocity of the motion of the representation based on the calculated time. If the velocity of the swipe is less than or equal to the high limit, the representation moves with the velocity of the swipe; however, if the velocity of the swipe is greater than the high limit, the representation moves with the high limit velocity. Alternatively, it is possible to move the representation with the high limit velocity or lower regardless of the velocity of the swipe. Alternatively, it is possible to transfer the data with speed corresponding to the velocity of the swipe, so that the animation and the data transfer ends at substantially the same time. Alternatively, the velocity of the representation can vary or decrease, the rate of deceleration depending on the calculated time. If the data is big, then the velocity of the representation decreases with a higher rate. In this example, we can equate the initial velocity of the representation with the velocity of the swipe even if the velocity of the swipe is really high, because then it is possible to set the deceleration rate as high as wanted (the representation is decelerated really quickly).

In one embodiment of the some embodiments, the first device transforms the velocity (Vs) of the swipe into the velocity (Vi) of the representation with a coefficient (C). Vi=C×Vs. The coefficient C decreases as the calculated time increases.

In one embodiment of the some embodiments, the first device adds an additional visual effect in the animation. For example, the representation of the item can go back and forth between screens of the first device and second device until, say, 90% of the data transfer is done, then the representation can go into the screen of the second device.

In some embodiments, actual data is downloaded later from the Internet with the body data just transmitting an identifier of the data on the server.

In some embodiments, a cancel button to cancel the transfer is added to the first screen 62 during or before the first animation. Undo function for undoing the transfer may be added, the undo function being triggered by swipe in the opposite direction on the first screen 62. The cancel button or the undo function is optional, since the first user of the first device already has to signal their intention to share by (i) selecting the item for sharing, (ii) swiping or dragging it. In the case of a larger file transfer that takes time, a cancel button may be added in any case to give the user a chance to cancel the transfer if it takes too long. In cases where the transfer of body data is swift, there may be two possible cases: the shared item is of marginal “cost” (like a business card) and in this case no need to worry. If the item represents real value, it is preferable for the user interface to be designed in such a way that the actual drag/swipe corresponds to the “OK” button of a “Do you really want to do this” alert.

In some embodiments, the value or data may be copied or shared instead of transferred or moved. In some embodiments, an access right to data is transferred or shared instead of the ownership or the data itself.

In some embodiments, files, photos or music stored in a cloud server is transferred or ownership of such is transferred or access right to such is transferred.

In some embodiments, the value transfer system is used for distributing tickets. The first device works as a distributor. The item A is regarded as a ticket. The second device works as a receiver. Once the first device finds another device (ex. the second device) in its close proximity, it sends the ticket to the found device through the direct connection.

In some embodiments, the value transfer system is used for distributing business cards. The item A is regarded as a business card of the first user. The account of a user on the server is regarded as an account of Social Network Service. Once the business card of the first user is sent to the second device successfully, the first user's SNS account is connected to the second user's SNS account on the server.

In some embodiments, the value transfer system is used for giving a part of the first user's points to the second user. For example, when the second user decides to buy a can of beverage costing one dollar and 25 cents from a vending machine (which is payable by electronic points), he/she finds that he/she only has one dollar worth of points. Then, the first user who is in close proximity says that he/she can give the second user 25 cents out of his/her account. In this situation, the embodiments can realize the quick and easy transaction of 25 cents from the first user to the second user, without any complicated security measures.

In some embodiments, the embodiments can be applied to share any type of data between mobile devices in close proximity. For example, a customer loyalty application allows users to share points, offers, or coupons in such a way that the sharing user loses ownership of the item being shared. Alternatively, a photo application allows users to swipe over a photo.

In some embodiments, characteristic parameters include tap-down duration, interval of successive taps or the number of taps.

In some embodiments, the actual distance between the devices is estimated using signal strength, and interaction is restricted to close proximity, protecting privacy and enhancing usability.

In some embodiments, the technical concepts of the embodiments can be applied to cloud computing.

Any combination of any of the embodiments described above is possible.

What is claimed is:

1. A method for interaction between a first device and a second device, comprising:
establishing, by the first device, direct connection with the second device;
when at least one action for associating at least one electronic object associated with the first device with the second device is detected at the first device, sending, by the first device and to the second device, first data for enabling synchronized animations on displays of the first and second devices, through the established direct connection; and
sending, by the first device and to a server which manages the at least one electronic object, second data for permitting the association of the at least one electronic object with the second device, through a network.

2. The method of claim 1, wherein the network does not include the direct connection.

3. The method of claim 1, wherein each of the first and second devices comprises a touch screen, and
the method further comprises:
displaying, on the touch screen of the first device, a representation of the at least one electronic object; and
detecting an action to the displayed representation on the touch screen of the first device as the at least one action for associating.

4. The method of claim 3, wherein the detected action to the displayed representation includes a swipe or a drag of the displayed representation, and
wherein the first data includes data characterizing the swipe or the drag.

5. The method of claim 4, further comprising:
displaying the synchronized animation on the touch screen of the first device, in which the displayed representation gradually disappears as a corresponding representation gradually appears on the touch screen of the second device.

6. The method of claim 5, wherein, in the synchronized animation on the touch screen of the first device, the displayed representation moves toward an edge of the touch screen and disappears as it hits the edge, and
wherein, when a portion of the displayed representation has disappeared at the edge of the touch screen of the first device, a corresponding portion is displayed at an edge of the touch screen of the second device.

7. The method of claim 6, wherein the remaining portion of the displayed representation displayed on the touch screen of the first device and the corresponding portion displayed on the touch screen of the second device together form the original displayed representation.

8. The method of claim 3, wherein the synchronized animations are generated based on the difference in an aspect ratio of the touch screen between the first device and the second device.

9. A device comprising a processor and a memory connected to the processor, the memory storing a program which, when executed by the processor, causes the processor to:
establish direct connection with another device;
when at least one action for associating at least one electronic object associated with the device with the another device is detected at the device, send, to the another device, first data for enabling synchronized animations on displays of the device and the another device, through the established direct connection; and
send, to a server which manages the at least one electronic object, second data for permitting the association of the at least one electronic object with the another device, through a network.

10. A non-transitory computer-readable storage medium storing a program which, when executed by a processor of a device, causes the processor to:
establish direct connection with another device;
when at least one action for associating at least one electronic object associated with the device with the another device is detected at the device, send, to the another device, first data for enabling synchronized animations on displays of the device and the another device, through the established direct connection; and
send, to a server which manages the at least one electronic object, second data for permitting the association of the at least one electronic object with the another device, through a network.
